(19) United States
(12) Patent Application Publication
(10) Pub. No.: US 2004/0142143 A1
(43) Pub. Date: Jul. 22, 2004

(54) Moulding materials

(76) Inventors: Thomas Corden, York (GB); Arshad Choudry, Nottingham (GB); Mark Raymond Steele, Derbyshire (GB)

Correspondence Address: SMITH-HILL AND BEDELL, 12670 N W BARNES ROAD, SUITE 104, PORTLAND, OR, 97229

(21) Appl. No.: 10/475,687

(22) PCT Filed: Apr. 23, 2002
(86) PCT No.: PCT/GB02/01863

(30) Foreign Application Priority Data
Apr. 27, 2001 (GB) 0110316.7

(51) Int. Cl. B32B 3/06; B32B 9/00; B32B 5/02; B32B 27/04; B32B 27/12; B32B 1/00; D06N 7/04; B32B 3/12; B32B 3/26; D03D 15/00; D03D 25/00; B32B 3/00; B32B 5/16; B32B 7/00; B32B 7/02

(52) U.S. Cl. 428/103; 442/208; 442/218; 428/104; 428/213; 428/206; 442/113; 442/210; 428/159; 428/144; 428/147

(57) ABSTRACT

A moulding material comprising a fibrous layer carrying resinous material to have at lest one area of relatively high resin content and at least one other area of relatively low resin content defined on a surface of the fibrous layer such that upon curing or partial curing resin from the said relatively high resin content area(s) moves over the relatively low resin content area(s) to provide a substantially even distribution of resin between the areas.

The present invention concerns improvement in or relating to moulding materials and methods for producing moulding materials.

Moulding materials particularly for moulding fibre reinforced moulded articles are known in the form of a layer of fibrous material which is fully impregnated with a predetermined amount of resinous material. These are conventionally known as prepregs. Such prepregs are laminated usually within a mould and then cured to produce a composite, fibre reinforced moulded article.

A particular disadvantage of such prepregs is that during moulding air can become trapped between the layers of prepreg which will cause voidage on a macro and microscopic level. Such voidage will cause weaknesses and other undesirable characteristics in the moulded article.

Various methods have been employed to address this problem, and one such method is to use moulding materials comprising a layer of fibrous material on one side of which is provided a layer of resinous material. This resinous layer may sometimes be partially impregnated into the fibrous layer.

The unimpregnated surface of the fibrous layer provides air paths for trapped air to move along as it is drawn out during the moulding process which conventionally employs the use of a vacuum to draw the trapped air from the material.

Such sided prepregs have proved useful, particularly when the resinous material used cures at relatively high temperatures, i.e. above approximately 120° C. However problems can occur if curing is required at relatively low temperatures, e.g. room temperature to approximately 120° C. because for such low temperature curing the resins used have relatively low viscosity which results in the resin gradually migrating into and impregnating the fibrous layer and relatively rapid loss of the sided nature of the prepreg.

A further disadvantage of sided prepregs arises when, as is usual, it is required that the material will stick or tack to a tool face and subsequent layers of prepreg. The dry, fibrous layers will have no tacky characteristic, i.e. zero tack, and so retaining such prepregs in the desired position within a mould often requires the use of other agents such as tackifiers, binders and spray adhesives. Such agents however can “wet-out” the dry fibrous layer, thereby eliminating the necessary air paths to achieve low voidage levels. Such agents can also have other disadvantages, for example they can reduce mechanical properties such as inter-laminar shear and are often solvent based resulting in environmental and health and safety problems. Moulding with sided prepregs can be laborious and can often result in a loss of definition in a moulded article, especially at sharp corners and details.

According to the present invention there is provided a moulding material comprising a fibrous layer carrying a resinous material to have at least one area of relatively high resin content and at least one other area of relatively low resin content defined on a side of the fibrous layer.

Preferably the moulding material is arranged such that during curing or partial curing resinous material moves to provide a substantially even distribution of resinous material between the areas.

Preferably the material is arranged so that during curing resinous material from the said relatively high resin content area(s) moves over the relatively low resin content area(s).

Preferably the resinous material is flowable during curing into the area(s) of relatively low resin content to impregnate the fibrous layer.

Preferably the or one or more of the area(s) of relatively low resin content are substantially devoid of resin and desirably comprise substantially dry fibrous material.

Preferably the or one or more of the area(s) of relatively high resin content impregnate the fibrous layer, at least partially, and preferably extend through the fibrous layer to provide resinous surface area on both sides of the fibrous layer. The amount of resin may differ on the respective sides of the layer. Preferably the resinous surface area is substantially the same on the respective sides of the fibrous layer.

Alternatively the area(s) of relatively high resin content is/are provided on a single side of the fibrous layer. The fibrous layer may comprise a prepreg.

According to a still further alternative one or more areas of relatively high resin content and of relatively low resin content may be provided on each side of the fibrous layer, the or at least one of the area(s) on one of said sides being discrete from the or at least one of the areas on said other side.

Preferably the amount of resinous material in each relatively high resin content area is substantially the same. Alternatively the amount of resinous material may differ between some or all of the said relatively high resin content areas.

Preferably a pattern of areas of relatively high resin content is provided on the fibrous layer, which pattern may comprise a plurality of similar areas such as bands, stripes, squares or other geometric shapes. The pattern of areas of relatively high resin content may be generally directional and may extend in a predetermined direction relative to a direction characteristic of the fibrous layer. For example bands of relatively high resin content may extend generally perpendicularly to the weft of a fibrous layer comprising woven material.

Alternatively or in addition the pattern may comprise various areas extending along both the warp and weft of a layer of woven fibrous material.

Alternatively or in addition, the pattern may define one or more symbols such as letters, words, logos or the like.

Regions may be provided on the moulding material and a pattern of areas of relatively high resin content provided in at least one and desirably all of said regions. The pattern may be the same in some or all of the regions or alternatively a different pattern may be located in some or each region in which a pattern is provided. The regions may be defined at least in part, by fold lines or locations at which the material is or is intended to be folded or bent particularly in a mould during use.

Preferably the resinous material is sufficiently viscous to substantially remain in the desired area(s) for a predetermined time, desirably to enable the moulding material to be generally stable for use for at least the outlife of the resinous material, desirably for approximately 10 days or more, whilst preferably enabling the moulding material to be curable at relatively low temperatures, such as room temperature up to 120° C. and possibly up to 250° C.

The resinous material may comprise a thermosetting material including but not limited to any one or more of epoxy phenol novolaks, epoxy novolaks, epoxy cresol novolaks, bis phenol A epoxy resins, bis phenol F epoxy resins, multi functional resins, multi functional epoxy resin, phenolics, cyanate esters, BMI's, polyesters, thermoplastic materials, other thermosetting materials. The resinous material can contain up to 70% by weight, but ideally less than 40% by weight additives not covered by the above. These additives may fall into a number of categories, such as thermoplastics, flame-retardants, fillers and curing agents, including combinations and blends of the above and others well known to those skilled in the art.

Alternatively or in addition the resinous material may comprise a thermoplastic material.

The fibrous layer may comprise a single layer of fibrous material or alternatively may comprise a plurality of layers of material. The fibrous material may be generally continuous within the layer, such as woven material. Alternatively or in addition the fibrous material may be generally discontinuous within the layer, such as chopped mat material. The layers may comprise the same or alternatively different types of fibrous material. The fibrous material may comprise, but is not limited to one or more of glass fibre, carbon fibre, aramid, PE, PBO, boron natural fibres, stitched fabric, UD tape, non-woven material such as glass and/or polyester thermoplastic fibres or blends thereof. The fibrous layer may be partially or wholly pre-impregnated with further resinous material, which further resinous material may be the same or different to said resinous material.

The moulding material may comprise a further layer of material such as fibrous material and/or resinous material conjoined to one or more of the area(s) of relatively high resin content to one side of the fibrous layer. A said further layer may be provided on both sides of the moulding material.

Further according to the present invention there is provided a moulding laminate comprising a plurality of layers of moulding material substantially as defined above.

Preferably the area(s) of relatively low resin content in adjacent layers are in alignment one above the other.

Alternatively or also some or all the area(s) of relatively low resin content in adjacent layers are not in alignment one above the other, although they preferably, at least partially overlap between adjacent layers.

According to a still further aspect of the present invention there is provided a method of producing a moulding material the method comprising providing at least one area of relatively high resin content and at least one area of relatively low resin content on a side of layer of fibrous material.

The method is preferably used to produce moulding material substantially as defined above.

The area(s) of relatively high resin content may be printed, sprayed and/or painted on the fibrous material.

According to a yet further aspect of the present invention there is provided a method of moulding a composite material comprising heating moulding material as defined in any of the preceding twenty four paragraphs, to cause resinous material to move to be substantially evenly distributed between the areas.

Preferably the material is located in or against a mould or tool during moulding. The material is preferably located with area(s) of relatively high resin content located against the mould to facilitate location thereof during curing.

The material may be moulded in a substantial vacuum or otherwise low pressure conditions to facilitate removal of air via the area(s) of relatively low resin content.

Preferred embodiments of the present invention will now be described by way of example only with reference to the accompanying drawings in which:

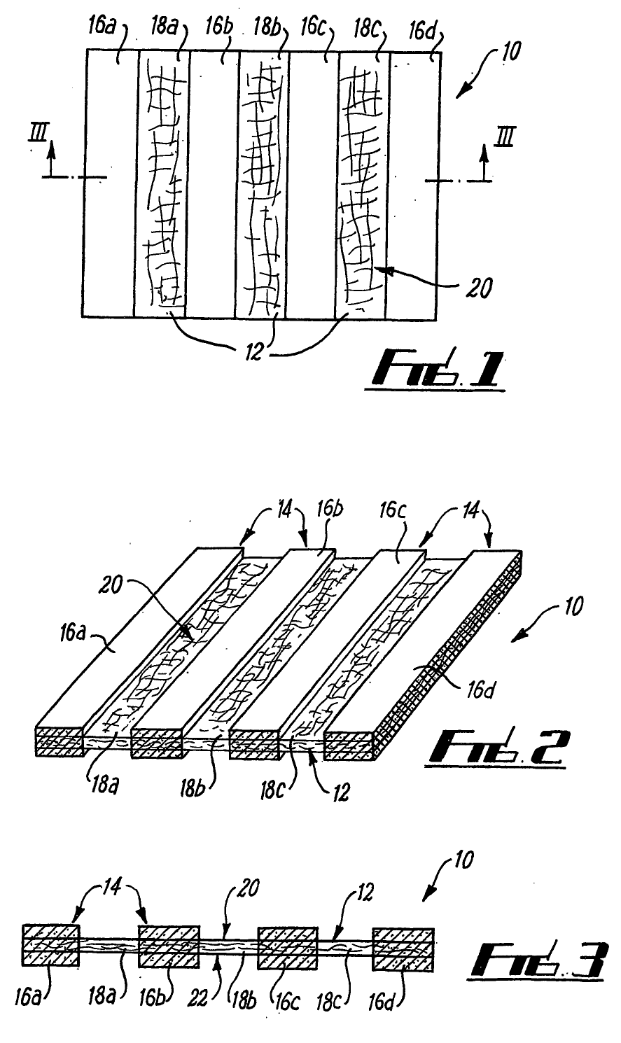

FIG. 1 is a diagrammatic plan view of a moulding material according to a first embodiment of the present invention;

FIG. 2 is a perspective view of the moulding material of FIG. 1;

FIG. 3 is a cross sectional view of the moulding material of FIG. 1, along the line III-III;

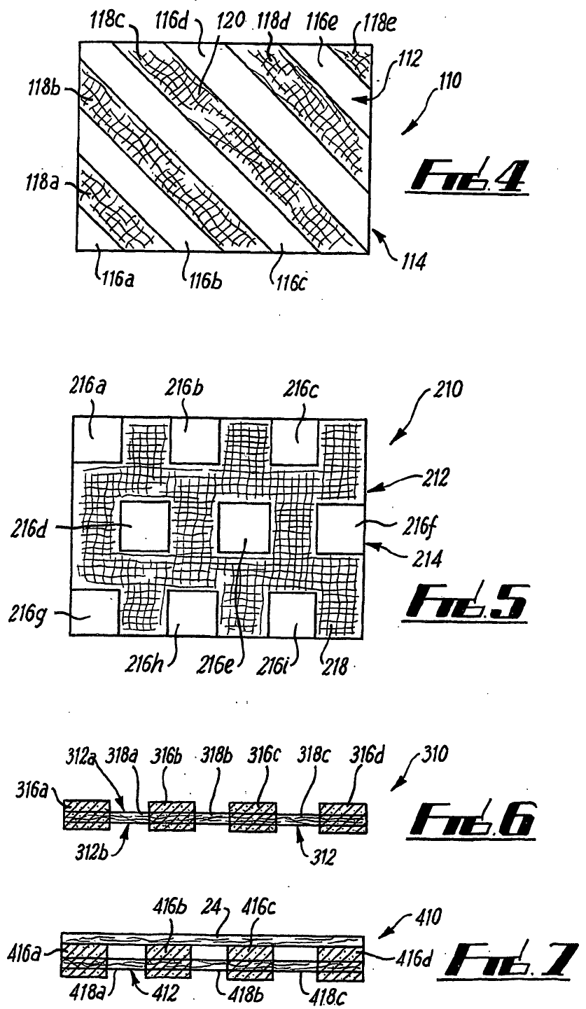

FIG. 4 is a plan view of a moulding material according to a second embodiment of the present invention;

FIG. 5 is a plan view of a moulding material according to a third embodiment of the present invention;

FIG. 6 is a cross sectional view of a moulding material according to a fourth embodiment of the present invention;

FIG. 7 is a cross sectional view of a moulding material according to a fifth embodiment of the present invention;

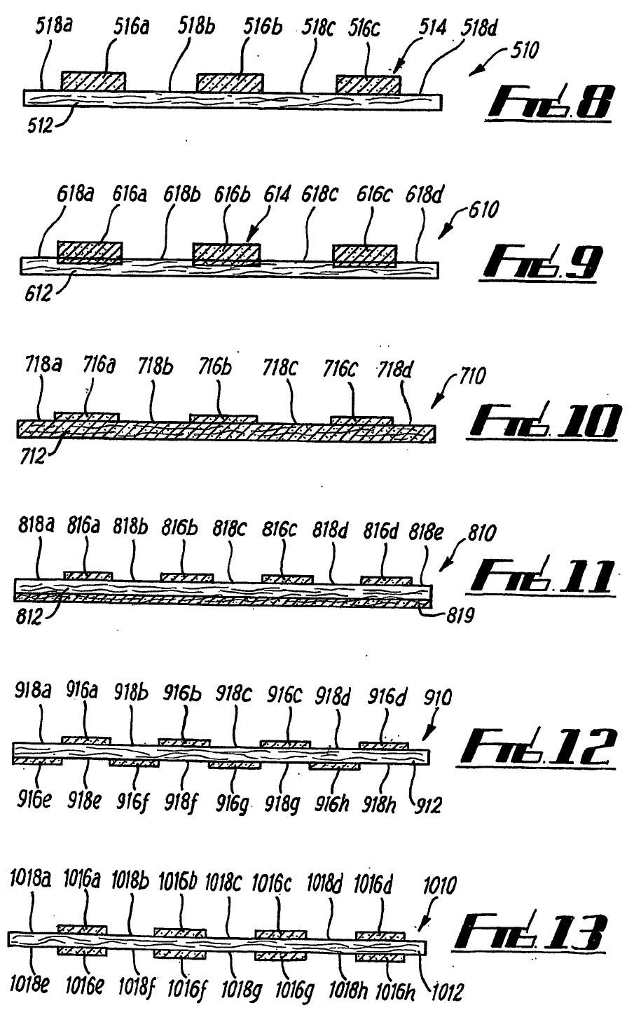

FIG. 8 is a cross sectional view of a moulding material according to a sixth embodiment of the present invention;

FIG. 9 is a cross sectional view of a moulding material according to a seventh embodiment of the present invention;

FIG. 10 is a cross sectional view of a moulding material according to an eighth embodiment of the present invention;

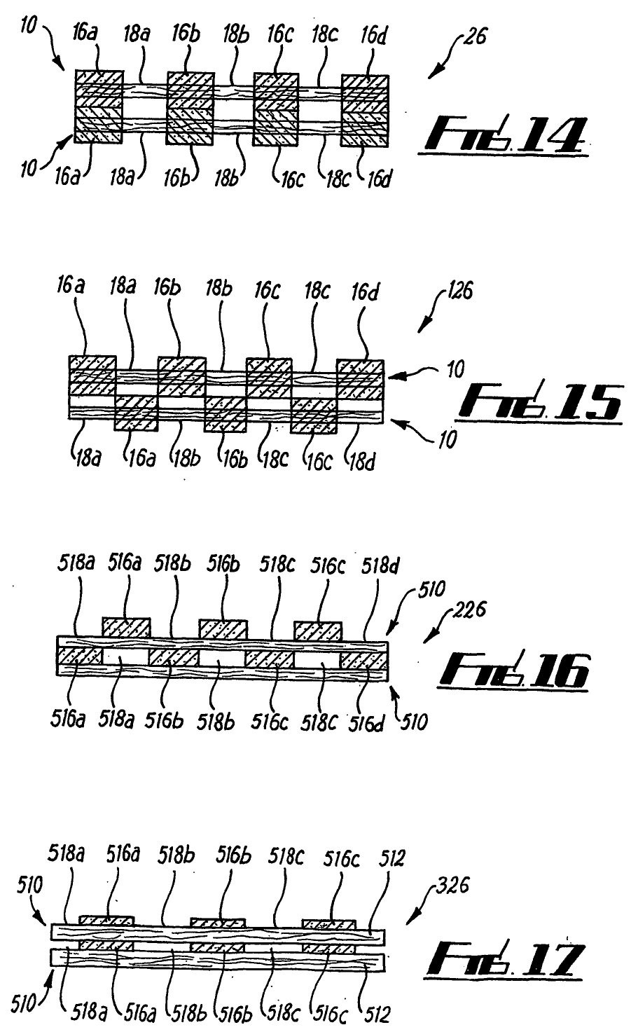

FIG. 11 is a cross sectional view of a moulding material according to a ninth embodiment of the present invention;

FIG. 12 is a cross sectional view of a moulding material according to a tenth embodiment of the present invention;

FIG. 13 is a cross sectional view of a moulding material according to a eleventh embodiment of the present invention;

FIG. 14 is a cross sectional view of a laminate moulding material according to the present invention;

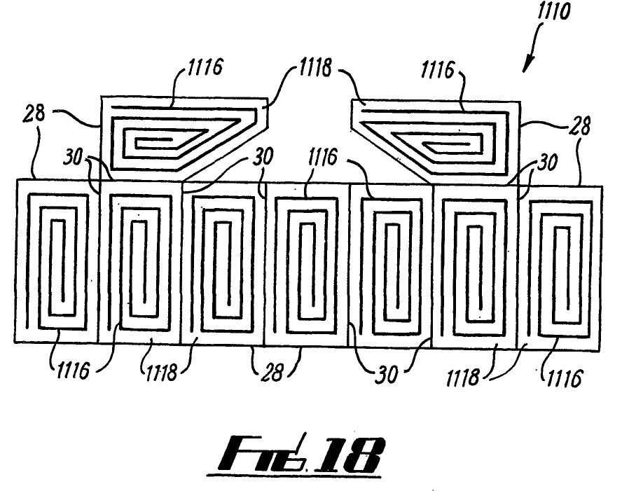

FIG. 15 is a cross section of a further laminate moulding material according to the present invention;

FIG. 16 is a is a cross section of a still further laminate moulding material according to the present invention;

FIG. 17 is a cross section of another laminate moulding material according to the present invention; and

FIG. 18 is a plan view of a moulding material according to a twelfth embodiment of the present invention.

Referring to FIGS. 1 to 3, there is provided a moulding material 10 comprising a fibrous layer 12 carrying resinous material 14 to have at least one and in this embodiment four areas 16a, 16b, 16c and 16d of relatively high resin content and at least one other, and in this embodiment three areas 18a, 18b and 18c of relatively low resin content defined on a surface 20 of the fibrous layer 12.

In more detail, the fibrous layer 12 comprises a single layer of any suitable fibrous material that could be used as reinforcement of an article produced using the moulding material 10. The material may comprise, for example, glass fibre, carbon fibre, aramid, PE, PBO, boron or natural fibres, stitched fabric, UD tape, non-woven materials such as glass or polyester; or any combination of the above.

The resinous material preferably comprises a low temperature curing, relatively low viscosity material, e.g. room temperature to 120° C. The resin material may comprise one or more of, for example epoxy phenol novolaks, epoxy novolaks, epoxy cresol novolaks, bis phenol A based epoxy resins, bis phenol F epoxy resins, multi functional resins such as multi functional epoxy resin, phenolics, cyanate esters, BMI's, polyesters, other thermosetting materials. However, it is within the scope of the present invention to use any suitable resinous material, including materials of relatively high cure temperatures (for example 250° C.) and thermoplastic materials.

The high resin content areas 16a, 16b, 16c and 16d are in the form of strips or bands extending in spaced configuration across the surface 20 of the fibrous material layer 12. The resin is wholly impregnated through the thickness of the fibrous layer 12 such that corresponding bands or strips are provided on the underside surface 22 of the fibrous layer 12.

Referring particularly to FIGS. 2 and 3, the resin bands 16a, 16b, 16c and 16d protrude from both sides 20, 22 of the fibrous layer 12 to substantially the same depth, although it will be appreciated in a further alternative that the amount of resin on the respective surfaces 20, 22 may differ.

The areas of low resin content 18a, 18b and 18c are essentially devoid of any resin and comprise essentially dry fibrous materials.

It is found that even relatively low viscosity resin has little tendency to migrate in a lateral direction to further impregnate the layer of woven material. This gives the moulding material 10 good stability, particularly relative to known sided prepregs. Moreover, the provision of resin on both surfaces 20, 22 of the fibrous layer 12 gives the moulding material 10 tack on both surfaces which enables it to self-adhere to the inside of a mould when forming a moulded article, thereby overcoming other difficulties of known sided prepregs.

The low resin content areas 18a, 18b and 18c provide pathways for the movement and removal of air as material 10 is layered in a mould and during the moulding process.

The amount of resin provided in the relatively high resin content areas 16a, 16b, 16c and 16d is sufficient to ensure that during the curing cycle the resin flows over and impregnates the low resin content areas 18a, 18b and 18c to give the moulding material a generally uniform distribution of resin throughout and an overall appropriate amount of resin for the application of the material 10. The amount of resin is therefore carefully predetermined.

In use, the moulding material 10 can be used to produce a moulded article (not shown). Moulding material 10 is located over the inside surface of a mould or tool (not shown). The inherent surface tack of the moulding material 10 provided by the resin areas 16a, b, c, d facilitates secure location of material within a mould, thus overcoming some of the difficulties of known sided prepregs.

Layers of material 10 are located one above the other. As will be discussed later the precise location of areas of relatively high and low resin content can be chosen according to the particular application.

The layered material 10 is then subjected to a conventional curing cycle, preferably using vacuum processing. The areas of relatively low resin content provide air ways for the removal of air during curing. The curing, which can be conducted at any suitable temperature within the scope of the present invention, causes the resinous material to flow and impregnate the areas of relatively low resin content, until the distribution of resinous material is substantially even across the areas.

As mentioned above an advantage of the present invention is that resinous material in the area(s) of relatively high resin content has little or no tendency to migrate laterally into the area(s) of relatively low resin content. This enables relatively low viscosity resinous material to be used and still provide relatively stable material 10. This consequently enables low temperature (in the order of cure temperatures between room temperature and 180° C. although the cure temperature will depend upon the cure chemistry of the resinous material being used) curing resinous material to be used, providing for more efficient moulded article production.

The method of producing the moulded material 10 is also part of the present invention. One way that the moulding material can be prepared is to use printing techniques, such as screening printing or drum printing to essentially print the high content areas on the fibrous material. Further alternatives are to provide a robotic arrangement to apply the material for example by spraying, painting or otherwise depositing resinous material in a desired pattern.

FIG. 4 shows a moulding material 110 according to a second embodiment of the present invention. The structure of the material 110 is essentially the same as the material 10 and similar components and features are referenced with similar reference numerals, prefixed with the numeral “1”.

In this embodiment, the areas of relatively high resin content 116a, 116b, 116c, 116d and 116e extend generally diagonally over the fibrous material 112.

FIG. 5 shows a moulding material according to a third embodiment of the present invention, wherein the areas of relatively high resin content 216a, 216b, 216c, 216d, 216e, 216f, 216g, 216h, 216i are provided in a pattern of squares within a grid area of low resin content 218.

FIG. 6 shows a cross section, similar to the cross section of FIG. 3 of moulding material 310 according to a fourth embodiment of the present invention. In the material 310, the fibrous layer 312 comprises two sheets 312A, 312B of fibrous material which lie substantially adjacent to each other and through which areas of high resin content 316a, 316b, 316c and 316d extend.

The sheets 312a, 312b of fibrous material may be the same, or alternatively and preferably they may comprise different types of fibrous material for example one sheet may comprise carbon fibre, the other glass fibre. In a further alternative they may comprise the same or differing material placed in different orientations, such as mutually substantially perpendicularly.

FIG. 7 shows moulding material 410 according to a fifth embodiment of the present invention. The moulding material 410 is essentially the same as the moulding material 10, but comprises a layer of further material 24 conjoined to the surfaces of the pattern of high resin content area 416a, 416b, 416c and 416d. A layer of further material (not shown) may also be provided on the surfaces of the pattern on the other side of the material 410.

FIG. 8 shows a moulding material 510 according to a sixth embodiment of the present invention. The material 510 comprises a layer of fibrous material 512 on the surface of one side of which is a plurality of relatively high resin content areas 516a, b, c. Areas of low resin content 518a, b, c, d which are generally devoid of resin are located around and between the areas 516a, b, c. In this particular embodiment the resin 514 in the areas 516a, b, c, shows little or no impregnation into the fibrous layer 512.

FIG. 9 shows an alternative moulding material 610 which is similar to the material 510 of FIG. 8, other than the resin 614 of the areas of relatively high resin content are impregnated partially through the thickness of the fibrous layer 612.

FIG. 10 shows a moulding material 710 according to an eighth embodiment of the present invention in which the fibrous material 712 comprises a resin pre-impregnated fibrous material, or prepreg, on one side of which are areas of relatively high resin content 716a, b, c and areas of relatively low resin content 718a, b, c and d. It will be appreciated that areas of relatively high resin content can be provided on both sides of the fibrous material 712. Although air flow through the areas of relatively low resin content 718a, b, c, d is not as efficient in this embodiment due to the presence of resin in the fibrous layer 712, the spaces between the areas 716a, b, c facilitate air movement.

The moulding material 810 shown in FIG. 11 comprises a fibrous material layer 812 on one side of which is a plurality of relatively high resin content areas 816a, b, c, d and a plurality of relatively low resin content areas 818a, b, c, d, e and on the other side thereof is a substantially continuous layer of resinous material 819.

The moulding material 910 shown in FIG. 12 comprises a fibrous layer 912 on one side of the which is a first plurality of areas of relatively high resin content 916a, b, c, d and on the other side a second plurality of relatively high resin content areas 916 e, f, g, h all of said areas penetrating the fibrous layer a little or to no significant degree. The areas 916a, b, c, d are not in alignment with the areas 916e, f, g, h but are in alignment with the areas of relatively low resin content 918e, f, g, h and areas 916e, f, g, h are in alignment with the areas 918a, b, c, d.

The moulding material 1010 of FIG. 13 is generally similar to the material 910 of FIG. 12, but the areas of relatively high resin content 1016a, b, c, d on one side of the fibrous layer 1012 are generally in alignment with the relatively high resin content areas 1016e, f, g, h on the, other side. Similarly the areas of relatively low resin content 1018a, b, c, d on side one side are generally in alignment with the areas of relatively low resin content 1018e, f, g, h on the other side.

FIG. 14 shows a diagrammatic cross section of a moulding material laminate 26 according to the present invention. This comprises two (or more) layers of moulding material 10 located one above the other, with the high resin content areas in alignment one above each other. This laminate 26 can be produced outside the mould to provide further moulding material, or alternatively could be produced within a mould when producing a composite material. It will be appreciated that any of the embodiments of moulding material within the scope of this invention, in particular those exemplified herein can be layered in this way to produce laminated moulding material according to the invention.

FIG. 15 shows a further moulding material laminate 126 which is again constructed in similar fashion to the laminate of FIG. 14, but with the high resin content areas 16a, 16b, 16c and 16d out of alignment between adjacent layers. The laminate 126 is illustrated with the low resin content areas 18a, 18b, 18c with no overlap. However it is considered preferable to retain some overlap between relatively low resin content areas between adjacent layers to facilitate air removal during moulded article production.

FIG. 16 is a cross section of laminate moulding material 226 according to a further embodiment of the present invention having layers of moulding material 510 in which areas of relatively high resin content 516a, b, c are provided on only one side of the fibrous layer 512 (such as the material of FIGS. 8, 9 and 10). The materials 510 are layered one on top of the other with the respective relatively high resin content 516a, b, c and 516a, b, c, d misaligned, with each other and generally aligned with the areas of relatively low resin content 518a, b, c, d and 518a, b, c respectively.

The laminate 326 of FIG. 17 is similar to that of FIG. 16, but with the areas of relatively high resin content 516a, b, c generally aligned between the layers of moulding material 510.

FIG. 18 shows moulding material 1110 according to a twelfth embodiment of the present invention. The material 1110 comprises a plurality of regions 28 each of which comprises a region of relatively high resin content 1116 and an area 1118 of relatively low resin content. Fold lines 30 join the respective regions 28. The material 1110 is laid into a mould or tool in similar manner as described above. The fold lines 30 of the material 1110 are predetermined to coincide with curves and comes in the mould and thereby facilitate location of the material 1110 in a mould.

It will be appreciated that the number and configuration of regions is chosen according to the shape of the Mould and/or moulded article in which the material 1110 is to be located or is to be formed.

It will be further appreciated that the fold lines may be pre-formed or partially pre-formed, or alternatively the regions may have no clear delineation between them.

The material 1110 may be layered on one or more such similar layers of material.

It will be appreciated that laminates can be produced by layering any number of the same or different combinations of moulding materials falling within the scope of this invention, either in partial, total or non-alignment, and the nature of alignment may vary between respective layers in multi-layer laminates.

Various modifications may be made without departing from the spirit or scope of the present invention. For example, the relatively low resin content area(s) may not be entirely devoid of resin, but may comprise some resin content although it is preferable that this is significantly lower than the resin content in the relatively high resin content area and sufficiently low for these areas to provide the desired pathways for air removal. As exemplified the fibrous material may be fully or partially pre-impregnated with resin (prepreg) or may comprise a sided prepreg having a layer of resin on one side thereof.

The amount of resinous material in the relatively high resin content areas can be the same or alternatively may differ between some or all of the said areas. The latter may be desirable if fabrics, such as net shape fabrics, which have varying fabric weight across the material, are used.

The fibrous material may be a discontinuous material, such as chopped mat. Alternatively or in addition the material may be continuous within the layer, such as a woven material and/or unidirectional material.

It is particularly envisaged that the resinous material used would be a thermosetting material, although thermoplastic material could be used within the scope of the present invention.

The pattern of high resin content area(s) and low resin content area(s) may be directional, for example as shown in relation to the first embodiment, and the direction of the pattern and thereby the direction of movement of resin during curing over the areas of low resin content can be chosen according to any directional characteristic of the fibrous material, such as the direction of the warp and weft of a woven material, to give the material desired characteristics.

It will be appreciated that the pattern of relatively high and relatively low resin content areas does not require to be symmetrical, and lettering, numerals or wording or other desired symbols may be employed to produce the respective areas.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Moulding material comprising a fibrous layer carrying a resinous material to have at least one area of relatively high resin content and at least one other area of relatively low resin content defined on a side of the fibrous layer.

2. Moulding material according to claim 1, in which the resinous material is arranged to move during curing or partial curing to provide a substantially even distribution of resinous material between the areas upon curing or partial curing.

3. Moulding material according to claim 2, in which during curing resinous material from the said relatively high resin content area(s) moves over the relatively low resin content area(s).

4. Moulding material according to claim 3, in which the resinous material is flowable during curing into the area(s) of relatively low resin content to impregnate the fibrous layer.

5. Moulding material according to any preceding claim, in which the or one or more of the area(s) of relatively low resin content are substantially devoid of resin.

6. Moulding material according to any preceding claim, in which the or one or more of the area(s) of relatively low resin content comprise(s) substantially dry fibrous material.

7. Moulding material according to any preceding claim, in which the or one or more of the area(s) of relatively high resin content impregnate the fibrous layer, at least partially.

8. Moulding material according to any preceding claim, in which the or one or more of the area(s) of relatively high resin content extend through the fibrous layer to provide resinous surface area on both sides of the fibrous layer.

9. Moulding material according to claim 8, in which the amount of resin differs on the respective sides of the layer.

10. Moulding material according to claim 8 or claim 9, in which the resinous surface area is substantially the same on the respective sides of the fibrous layer.

11. Moulding material according to any of claims 8 to 10, in which one or more areas of relatively high resin content and of relatively low resin content is/are provided on each side of the fibrous layer, the or at least one of the area(s) on one of said areas being discrete from the or at least one of the areas on said other side.

12. Moulding material according to any of claims 1 to 7, in which the area(s) of relatively high resin content is/are provided on a single side of the fibrous layer.

13. Moulding material according to any preceding claim, in which the fibrous layer comprises a prepreg.

14. Moulding material according to any preceding claim, in which the amount of resinous material in each relatively high resin content area is substantially the same.

15. Moulding material according to any of claims 1 to 13, in which the amount of resinous material differs between some or all of the said relatively high resin content areas.

16. Moulding material according to any preceding claim, in which a pattern of areas of relatively high resin content is provided on the fibrous layer.

17. Moulding material according to claim 16, in which the pattern comprises a plurality of similar areas such as bands, stripes, squares or other geometric shapes.

18. Moulding material according to claim 16 or claim 17, in which the pattern of areas of relatively high resin content is generally directional.

19. Moulding material according to claim 18, in which the pattern extends in a predetermined direction relative to a direction characteristic of the fibrous layer.

20. Moulding material according to any of claims 16 to 19, in which the pattern comprises various areas extending along both the warp and weft of a layer of woven fibrous material.

21. Moulding material according to any of claims 16 to 20, in which the pattern defines one or more symbols such as letters, words, logos or the like.

22. Moulding material according to any of claims 16 to 21, in which regions are provided on the moulding material and a pattern of areas of relatively high resin content provided in at least one of said regions.

23. Moulding material according to claim 22, in which the pattern is the same in some or all of the regions.

24. Moulding material according to claim 22, in which a different pattern is located in some or each region in which a pattern is provided.

25. Moulding material according to any of claims 22 to 24, in which the regions are defined at least in part, by fold lines or locations at which the material is or is intended to be folded or bent particularly in a mould during use.

26. Moulding material according to any preceding claim, in which the resinous material is sufficiently viscous to substantially remain in the desired area(s) for a predetermined time.

27. Moulding material according to claim 26, in which the resinous material is sufficiently viscous to enable the moulding material to be generally stable for use for at least the outlife of the resinous material.

28. Moulding material according to claim 26 or claim 27, in which the resinous material is curable at relatively low temperatures, such as room temperature up to 120° C.

29. Moulding material according to any preceding claim, in which the resinous material comprises a thermosetting material including any one or more of epoxy phenol novolaks, epoxy novolaks, epoxy cresol novolaks, bis phenol A epoxy resins, bis phenol F epoxy resins, multi functional resins, multi functional epoxy resin, phenolics, cyanate esters, BMI's, polyesters, thermoplastic materials, other thermosetting materials.

30. Moulding material according to claim 29, in which the resinous material contains up to 70% additives by weight.

31. Moulding material according to claim 30, in which the resinous material comprises less than 40% additives by weight.

32. Moulding material according to any of claims 30 or 31, in which the additives include one or more of thermoplastics, flame-retardants, fillers and curing agents, including combinations and blends thereof.

33. Moulding material according to any preceding claim, in which the resinous material comprises a thermoplastic material.

34. Moulding material according to any preceding claim, in which the fibrous layer comprises a single layer of fibrous material.

35. Moulding material according to any of claims 1 to 33, in which the fibrous layer comprises a plurality of layers of material.

36. Moulding material according to any preceding claim, in which the fibrous material is generally continuous within the layer, such as woven material.

37. Moulding material according to any preceding claim, in which the fibrous material is generally discontinuous within the layer, such as chopped mat material.

38. Moulding material according to any of claims 35 to 37, in which the layers comprise the same or alternatively different types of fibrous material.

39. Moulding material according to any preceding claim, in which the fibrous material comprises one or more of glass fibre, carbon fibre, aramid, PE, PBO, boron natural fibres, stitched fabric, UD tape, non-woven material such as glass and/or polyester thermoplastic fibres or blends thereof.

40. Moulding material according to any preceding claim, in which the fibrous layer is partially or wholly pre-impregnated with further resinous material.

41. Moulding material according to claim 40, in which the further resinous material is the same as said resinous material.

42. Moulding material according to claim 40, in which the further resinous material is different to said resinous material.

43. Moulding material according to any preceding claim, in which the moulding material comprises a further layer of material such as fibrous material and/or resinous material conjoined to one or more of the area(s) of relatively high resin content to one side of the fibrous layer.

44. Moulding material according to claim 43, in which said further layer is provided on both sides of the moulding material.

45. A moulding laminate comprising a plurality of layers of moulding material as defined in any of the preceding claims.

46. A moulding laminate according to claim 45, in which the area(s) of relatively low resin content in adjacent layers are in alignment one above the other.

47. A moulding laminate according to claim 44 or claim 46, in which some or all the area(s) of relatively low resin content in adjacent sheets are not in alignment one above the other.

48. A moulding laminate according to claim 47, in which the area(s) at least partially overlap between adjacent sheets.

49. A method of producing a moulding material the method comprising providing at least one area of relatively high resin content and at least one area of relatively low resin content on a side of a layer of fibrous material.

50. A method according to claim 49, in which the method is used to produce moulding material substantially as defined in any of claims 1 to 44.

51. A method according to any of claims 49 or 50, in which the area(s) of relatively high resin content are printed, sprayed and/or painted on the fibrous material.

52. A method of moulding a composite material comprising heating moulding material as defined in any of claims 1 to 44, to cause resinous material to move to be substantially evenly distributed between the areas.

53. A method according to claim 52, in which the material is located in or against a mould or tool during moulding.

54. A method according to claim 53, in which the material is located with area(s) of relatively high resin content located against the mould or tool to facilitate location thereof during curing.

55. A method according to any of claims 52 to 54, in which the material is moulded in a substantial vacuum or otherwise low pressure conditions to facilitate removal of air via the area(s) of relatively low resin content.

56. A method according to any of claims 52 to 55, in which the moulding material provided is a moulding laminate as defined in any of claims 45 to 48.

57. Moulding material substantially as hereinbefore described with reference to the any one or more of the accompanying drawings.

58. A moulding laminate substantially as hereinbefore described with reference to any one or more of the accompanying drawings.

59. A method substantially as hereinbefore described with reference to any one or more of the accompanying drawings.

60. Any novel subject matter or combination including novel subject matter disclosed herein, whether or not within the scope of or relating to the same invention as any of the preceding claims.
